(19) United States
(12) Patent Application Publication
(10) Pub. No.: US 2006/0011704 A1
(43) Pub. Date: Jan. 19, 2006

(54) Process for producing a deformed, locally reinforced sheet metal component and corresponding component

(76) Inventors: Martin Brodt, Weil der Stadt (DE); Michael Kirschbaum, Wolfschlugen (DE); Timo Wieland, Weinstadt (DE)

Correspondence Address: PENDORF & CUTLIFF, 5111 MEMORIAL HIGHWAY, TAMPA, FL, 33634-7356, US

(21) Appl. No.: 11/174,030

(22) Filed: Jul. 1, 2005

(30) Foreign Application Priority Data
Jul. 1, 2004 (DE) 10 2004 031 797.6

(51) Int. Cl. A47J 36/02

(52) U.S. Cl. 228/101

(57) ABSTRACT

The process is used to produce a deformed, locally reinforced sheet-metal component (10), in which a metal reinforcing sheet (14) is secured to a metal base sheet (12) by means of a brazed join (16) before or during the deformation process, characterized in that a nickel-based brazing material is used to produce the brazed join (16).

### BACKGROUND OF THE INVENTION

1. Field of the invention

The invention relates to a process for producing a deformed, locally reinforced sheet-metal component, in which a metal reinforcing sheet is secured to a metal base sheet by means of a brazed join before or during the deformation process, in accordance with the preamble of Claim 1.

Furthermore, the invention relates to a sheet-metal component in accordance with the preamble of Claim 9.

2. Related Art of the Invention

Processes and sheet-metal components of the type described in the introduction are known. By way of example, DE 100 49 660 A1 discloses a process for producing locally reinforced deformed sheet-metal parts, in which a metal reinforcing sheet is joined to a metal base sheet by brazing.

### SUMMARY OF THE INVENTION

It is an object of the invention to propose a particularly reliable process for producing a deformed, locally reinforced sheet-metal component.

A further object of the invention is to provide a corresponding sheet-metal component.

To achieve the object, the invention proposes a process having the features of Claim 1. The process according to the invention is characterized in that a nickel-based brazing material is used to produce the brazed join. A nickel-based brazing material is particularly suitable for brazing copper and copper alloys, nickel and nickel alloys, cobalt and cobalt alloys, any desired steels, including special steels, and some special metals and alloys thereof. This brazing material is particularly suitable for producing a stable join between two metal sheets, so as to form a locally reinforced sheet-metal component which is subjected to a deformation process after the brazed join has been produced. This is the “patchwork technique” which is known per se and according to which a metal reinforcing sheet is secured to a metal base sheet, for example by means of a brazed join, it then being possible for the locally reinforced sheet-metal component to be deformed by means of a suitable deformation tool. The stability of this brazed join using a nickel-based brazing material makes it possible to carry out a correct deformation process on the corresponding locally reinforced or “patched” sheet-metal component.

According to a preferred variant embodiment, the nickel-based brazing material contains 14% of chromium, 10.1% of phosphorous, remainder nickel. If appropriate, the nickel-based brazing material may additionally include trace amounts of silicon, boron, iron and carbon. In this case, the percentages mentioned may vary by +/−10%. A nickel-based brazing material of this type has proven particularly suitable for joining metal sheets so as to form a locally reinforced sheet-metal component which subsequently has to be subjected to a deformation process.

The melting point of the nickel-based brazing material is preferably approximately 890° C., and the brazing temperature of the nickel-based brazing material is preferably approximately 980° C. Therefore, during suitable thermal deformation of the metal sheets which are to be joined (metal base sheet, metal reinforcing sheet) at a deformation temperature which is higher than the melting point of the nickel-based brazing material, it is possible to produce a stable brazed join between these metal sheets and if appropriate also sufficient corrosion protection for the sheet-metal component. In a variant embodiment of this type, therefore, the production of the brazed join between the two metal sheets and the process of deforming the two metal sheets would be realized during a single manufacturing process step.

The nickel-based brazing material can be applied to the metal base sheet and/or to the metal reinforcing sheet in the form of a paste or by spraying or screen printing. The determination of a suitable embodiment depends, inter alia, on the sheet-metal materials and/or the surface condition thereof.

The metal base sheet and the metal reinforcing sheet can be produced from one steel or from different, if appropriate other materials. Therefore, the metal base sheet and/or the metal reinforcing sheet may also be produced from a light metal. This means that the nickel-based brazing material is versatile for use as part of the “patchwork technique”, satisfying the joining and/or deformation demands imposed in each case.

Furthermore, the object is achieved by a sheet-metal component having the features of Claim 9. The sheet-metal component may in particular be a bodywork component for a vehicle body. On account of the quality of join which can be reliably and reproducibly achieved, the nickel-based brazing material is particularly suitable for use in series production of locally reinforced sheet-metal components.

Further advantages of the invention will emerge from the description.

### BRIEF DESCRIPTION OF THE DRAWINGS

The invention is explained in more detail on the basis of a preferred exemplary embodiment and with reference to a diagrammatic drawing, in which:

FIG. 1 shows a diagrammatic perspective view of a locally reinforced sheet-metal component prior to a deformation process which is to be carried out, and

FIG. 2 shows a diagrammatic sectional illustration on section line II-II through the sheet-metal component illustrated in FIG. 1.

### DETAILED DESCRIPTION OF THE INVENTION

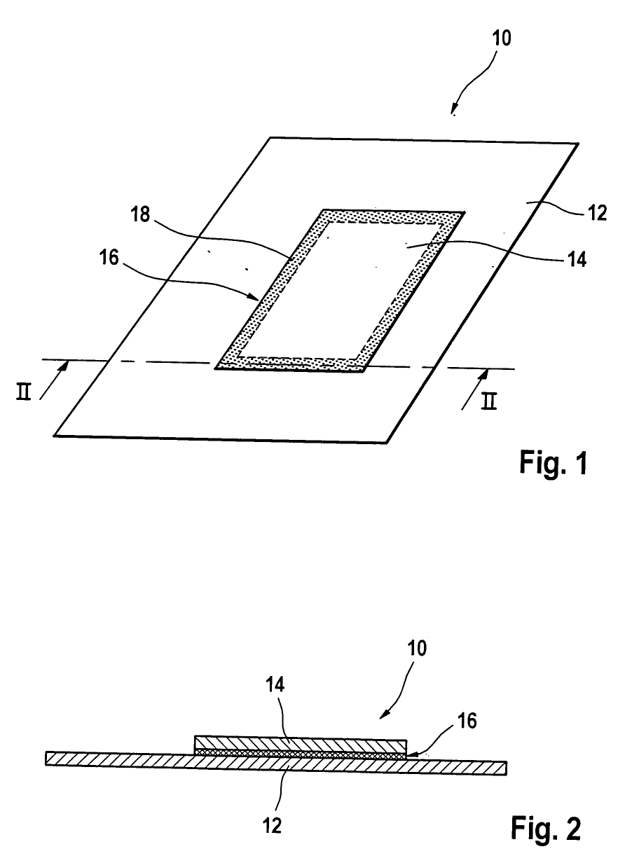

FIG. 1 shows a diagrammatic perspective illustration of a locally reinforced sheet-metal component 10 which includes a metal base sheet 12 and a metal reinforcing sheet 14. The metal reinforcing sheet 14 is secured to the metal base sheet 12 by means of a brazed join 16; the brazed join 16 is also illustrated in the diagrammatic sectional illustration presented in FIG. 2. In the embodiment illustrated, the brazed join 16 preferably extends along a continuous edge region 18 of the metal reinforcing sheet 14.

A nickel-based brazing material, which preferably contains 14% of chromium, 10.1% of phosphorous, remainder nickel, as well as trace amounts of silicon, boron, iron and carbon, is used to produce the brazed join 16.

The locally reinforced sheet-metal component 10 involves what is known as the “patchwork technique”, which is known per se. The novel use of a nickel-based brazing material in the “patchwork technique” allows the production of a particularly stable join between the metal base sheet 12 and the metal reinforcing sheet 14, and the sheet-metal component 10 which is thereby obtained can then be subjected to a deformation process by means of a suitable deformation tool. If appropriate, the solder join may also be formed during the deformation process rather than before the deformation process; in this case, the deformation process must be a suitable thermal deformation process involving a sufficiently high deformation temperature.

The metal base sheet 12 and the metal reinforcing sheet 14 may consist of the same material or of different materials. In particular, the metal base sheet 12 and metal reinforcing sheet 12 may consist of steel or of other metals (for example light metals).

The brazing process using the nickel-based brazing material is carried out in particular in vacuo or in a shielding gas atmosphere.

1. A process for producing a deformed, locally reinforced sheet-metal component (10), comprising:
subjecting the sheet-metal component to a deforming process, and
securing a metal reinforcing sheet (14) to a metal base sheet (12) by means of a brazed join (16) before or during the deformation process,
wherein a nickel-based brazing material is used to produce the brazed join (16).

2. The process according to claim 1, wherein the nickel-based brazing material contains about 14% of chromium, about 10.1% of phosphorous, remainder nickel.

3. The process according to claim 2, wherein the nickel-based brazing material additionally includes trace amounts of silicon, boron, iron and carbon.

4. The process according to claim 1 wherein the melting point of the nickel-based brazing material is approximately 890° C., and the brazing temperature of the nickel-based brazing material is approximately 980° C.

5. The process according to claim 1 wherein the nickel-based brazing material is applied to at least one of the metal base sheet (12) and the metal reinforcing sheet (14) in the form of a paste or by spraying or screen printing.

6. The process according to claim 1 wherein the metal base sheet (12) and the metal reinforcing sheet (14) are produced from one steel.

7. The process according to claim 1 wherein the metal base sheet (12) and the metal reinforcing sheet (14) are produced from different metals.

8. The process according to claim 1 wherein at least one of the metal base sheet (12) and the metal reinforcing sheet (14) are produced from a light metal.

9. A deformed, locally reinforced sheet-metal component (10) produced by subjecting the sheet-metal component to a deforming process, and securing a metal reinforcing sheet (14) to a metal base sheet (12) by means of a brazed join (16) produced by a nickel-based brazing material before or during the deformation process.
